(19) United States
(12) Patent Application Publication
(10) Pub. No.: US 2026/0228381 A1
(43) Pub. Date: Aug. 6, 2026

(54) LAYOUT DESIGN SUPPORT DEVICE, LAYOUT DESIGN SUPPORT METHOD, AND NON-TRANSITORY COMPUTER-READABLE RECORDING MEDIUM

(71) Applicant: JGC CORPORATION, Kanagawa (JP)

(72) Inventors: Sachiko KAIDA, Kanagawa (JP); Noriyuki TAKAHASHI, Kanagawa (JP); Tabito ARAI, Kanagawa (JP); Hiroyuki KOITO, Kanagawa (JP); Naoki KANO, Kanagawa (JP)

(73) Assignee: JGC CORPORATION, Kanagawa (JP)

(21) Appl. No.: 19/151,330

(22) PCT Filed: May 31, 2023
(86) PCT No.: PCT/JP2023/020340

§ 371 Date: Jul. 28, 2025

(51) Int. Cl. G06F 30/18; G06F 30/13; G06F 113/14; G06F 113/16

(52) U.S. Cl. CPC G06F 30/18; G06F 30/13; G06F 2113/14; G06F 2113/16

(57) ABSTRACT

Provided is a layout design support device for supporting design of a layout of underground facilities buried in underground of a plant, the support device including: an information acquisition module configured to acquire ground layout information relating to a layout of ground facilities arranged on ground of the plant, and design condition information relating to design of the underground facilities; a generation module configured to generate, based on the ground layout information and the design condition information, positions of a plurality of water collection points into which a liquid is collected from the ground of the plant, and a first piping route along which piping that discharges, from the plant, the liquid collected into the plurality of water collection points is buried in the underground of the plant; and an output module configured to output underground layout information indicating the positions of the water collection points and the first piping route.

### TECHNICAL FIELD

The present disclosure relates to a layout design support device, a layout design support method, and a layout design support program.

### BACKGROUND ART

There is known a technology for automatically generating layout information indicating an arrangement of devices, components, and the like by a computer in design of a plant. For example, in WO 2022/254888 A1 (hereinafter referred to as “Patent Literature 1”), there is described a technology in which a plurality of devices are classified into a plurality of device groups, the plurality of device groups are arranged on a floor, and then a plurality of devices included in each of the plurality of device groups are arranged.

### SUMMARY OF INVENTION

However, although the devices can be automatically arranged on the floor with the technology as described in Patent Literature 1, Patent Literature 1 includes no description concerning layout design of underground facilities buried in the underground of a plant. The layout design of the underground facilities is different from layout design of ground facilities arranged on the ground of a plant in the following points, for example. The layout design of the underground facilities is subject to constraints of a plot plan of the ground facilities, such as impossibility of burial of the underground facility under a foundation of the ground facility. Further, constructability is required to be considered. Thus, the layout design of the underground facilities involves many experiential factors. In addition, the layout design of the underground facilities is executed after the layout design of the ground facilities, and thus the time left until construction start is limited. Thus, increase in efficiency is desired.

The present disclosure has been made in view of the above-mentioned problem, and an object thereof is to provide a layout design support device with which part of layout design of underground facilities of a plant is automated so that efficiency of the layout design of the underground facilities can be increased.

According to one embodiment of the present disclosure, there is provided a layout design support device for supporting design of a layout of underground facilities buried in underground of a plant, the layout design support device including: an information acquisition module configured to acquire ground layout information relating to a layout of ground facilities arranged on ground of the plant, and design condition information relating to design of the underground facilities; a generation module configured to generate, based on the ground layout information and the design condition information, positions of a plurality of water collection points into which a liquid is collected from the ground of the plant, and a first piping route along which piping that discharges, from the plant, the liquid collected into the plurality of water collection points is buried in the underground of the plant; and an output module configured to output underground layout information indicating the positions of the plurality of water collection points and the first piping route.

With the layout design support device according to the present disclosure, part of layout design of the underground facilities of the plant is automated so that efficiency of the layout design of the underground facilities can be increased.

### BRIEF DESCRIPTION OF DRAWINGS

FIG. 1 (a) is a configuration diagram of a layout design support system according to an embodiment of the present disclosure, and (b) is a block diagram of a designer terminal device illustrated in (a).

FIG. 2 is a block diagram of a layout design support device illustrated in (a) of FIG. 1.

FIG. 3 (a) is a data configuration diagram of ground layout information illustrated in FIG. 2, and (b) of FIG. 3 is a data configuration diagram of design condition information illustrated in FIG. 2.

FIG. 4 is a diagram for illustrating an example of a ground layout drawing corresponding to ground layout drawing information illustrated in (a) of FIG. 3.

FIG. 5 is a flowchart of layout design support processing executed by the layout design support device illustrated in (a) of FIG. 1.

FIG. 6 is a diagram for illustrating an image in which a first water collection region is superimposed on a ground layout corresponding to the ground layout drawing information acquired in a processing step of Step S101 illustrated in FIG. 5.

FIG. 7 is a flowchart for illustrating more detailed processing of a processing step of Step S103 illustrated in FIG. 5.

FIG. 8 is an explanatory diagram for illustrating processing steps of Step S201 and Step S202 illustrated in FIG. 7.

FIG. 9 is an explanatory diagram for illustrating a processing step of Step S204 illustrated in FIG. 7.

FIG. 10 is an explanatory diagram (first diagram) for illustrating a processing step of Step S207 illustrated in FIG. 7.

FIG. 11 is an explanatory diagram (second diagram) for illustrating the processing step of Step S207 illustrated in FIG. 7.

FIG. 12 is an explanatory diagram for illustrating a processing step of Step S209 illustrated in FIG. 7.

FIG. 13 is a flowchart for illustrating more detailed processing of a processing step of Step S104 illustrated in FIG. 5.

FIG. 14 is an explanatory diagram for illustrating a processing step of Step S301 illustrated in FIG. 13.

FIG. 15 is an explanatory diagram for illustrating a processing step of Step S302 illustrated in FIG. 13.

FIG. 16 is an explanatory diagram for illustrating a processing step of Step S303 illustrated in FIG. 13.

FIG. 17 is a diagram for illustrating an image in which a second water collection region is superimposed on the ground layout drawing corresponding to the ground layout drawing information acquired in the processing step of Step S101 illustrated in FIG. 5.

FIG. 18 is an explanatory diagram for illustrating a processing step of Step S105 illustrated in FIG. 5.

FIG. 19 is a diagram for illustrating an image displayed on a display unit of the designer terminal device in accordance with a processing step of Step S108 illustrated in FIG. 5.

FIG. 20 is a diagram for illustrating an image displayed on the display unit of the designer terminal device in accordance with a processing step of Step S112 illustrated in FIG. 5.

### DESCRIPTION OF EMBODIMENTS

A layout design support device, a layout design support method, and a layout design support program for supporting design of a layout are described below with reference to the drawings. However, it should be understood that the present invention is not limited by the drawings or an embodiment to be described below.

### Layout Design Support System According to Embodiment

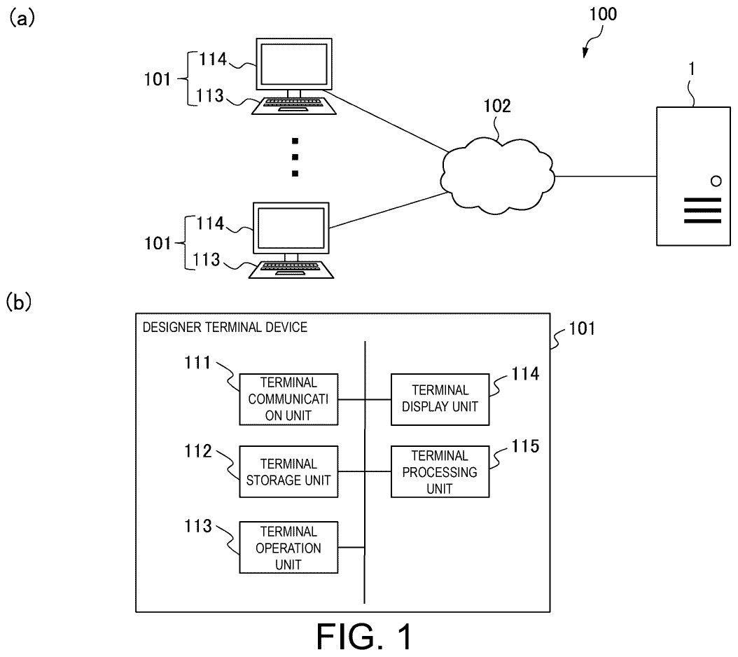

In FIG. 1, (a) is a configuration diagram of a layout design support system according to an embodiment of the present disclosure. In FIG. 1, (b) is a block diagram of a designer terminal device illustrated in (a) of FIG. 1.

A layout design support system 100 includes a plurality of designer terminal devices 101 and a layout design support device 1, and supports design of a layout of underground facilities including underground buried objects such as water collection facilities, piping, and cables buried in the underground of a plant. The layout design support device 1 is connected to each of the plurality of designer terminal devices 101 communicably through a network 102 including the Internet, an intranet, and the like.

The designer terminal device 101 is a general-purpose or dedicated computer that includes a terminal communication unit 111, a terminal storage unit 112, a terminal operation unit 113, a terminal display unit 114, and a terminal processing unit 115 and that is a used by a designer who designs the plant. The terminal communication unit 111 is a configuration for enabling the designer terminal device 101 to communicate to and from the layout design support device 1, and includes a communication interface circuit. The communication interface circuit is, for example, a communication interface circuit for a wired LAN, a wireless LAN, Long Term Evolution (LTE), or the like. The terminal communication unit 111 supplies data received from the layout design support device 1 to the terminal processing unit 115, and transmits data supplied from the terminal processing unit 115 to the layout design support device 1.

The terminal storage unit 112 is a configuration for storing data and programs, and includes, for example, a semiconductor memory. The terminal storage unit 112 stores an operating system program, driver programs, application programs, data, and the like used for processing executed by the terminal processing unit 115. The terminal operation unit 113 is a configuration for receiving operation executed by the designer who designs a layout of the plant by using the designer terminal device 101, and includes, for example, a keypad. The terminal operation unit 113 generates a signal in accordance with the operation executed by the designer, and supplies the signal to the terminal processing unit 115. The terminal display unit 114 is a configuration for displaying an image, and includes a display such as a liquid crystal display or an organic electroluminescence (EL) display. The terminal display unit 114 generates and displays an image based on a signal supplied from the terminal processing unit 115.

The terminal processing unit 115 includes one or a plurality of processors and a peripheral circuit thereof. The terminal processing unit 115 integrally controls overall operation of the designer terminal device 101, and is, for example, a CPU. The terminal processing unit 115 executes processing based on the program (driver program, operating system program, application program, or the like) stored in the terminal storage unit 112. The terminal processing unit 115 can execute a plurality of programs (application programs and the like) in parallel.

### Configuration and Functions of Layout Design Support Device According to Embodiment

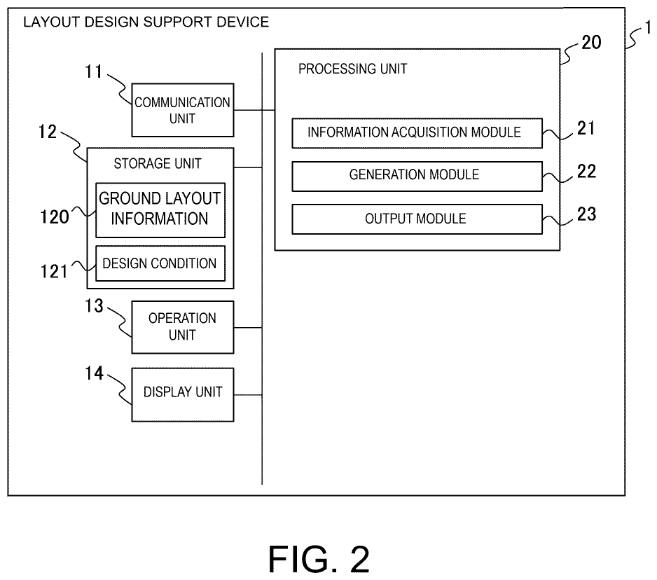

FIG. 2 is a block diagram of the layout design support device according to the embodiment.

The layout design support device 1 includes a communication unit 11, a storage unit 12, an operation unit 13, a display unit 14, and a processing unit 20, and is configured by, for example, a server-type computer or a cloud-type computer. The communication unit 11 is a configuration for enabling the layout design support device 1 to communicate to and from each of the plurality of designer terminal devices 101, and includes a communication interface circuit. The communication interface circuit is, for example, a communication interface circuit for a wired LAN, a wireless LAN, LTE, or the like. The communication unit 11 supplies data received from the plurality of designer terminal devices 101 to the processing unit 20, and transmits data supplied from the processing unit 20 to each of the plurality of designer terminal devices 101.

The storage unit 12 is a configuration for storing data and programs, and includes, for example, a semiconductor memory. The storage unit 12 stores an operating system program, driver programs, application programs, data, and the like used for processing executed by the processing unit 20. For example, the storage unit 12 stores a layout design support program for causing the processing unit 20 to execute layout design support processing of supporting layout design of the plant. For example, the layout design support program is installed in the storage unit 12 from a computer-readable and non-transitory portable storage medium such as a CD-ROM or a DVD-ROM, or another server connected communicably through the network 102. Further, the storage unit 12 stores various pieces of data and information used when the layout design support processing is executed. For example, the storage unit 12 stores ground layout information 120 and design condition information 121.

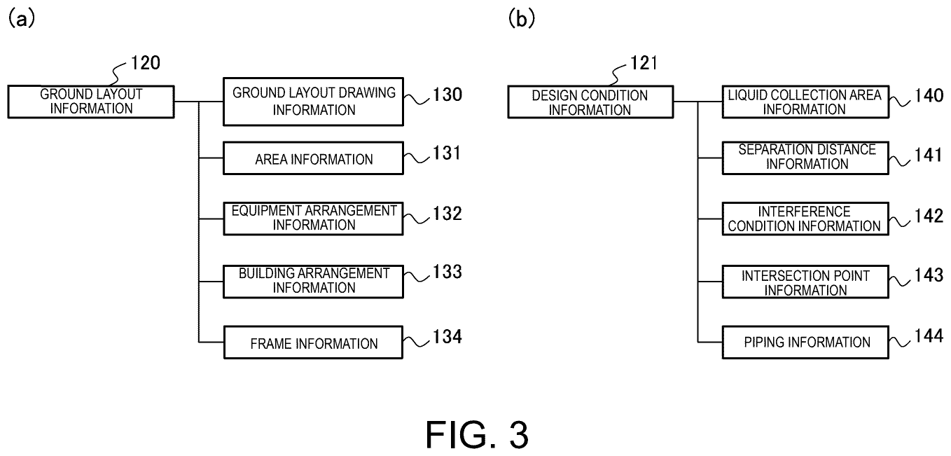

In FIG. 3, (a) is a data configuration diagram of the ground layout information 120. In FIG. 3, (b) is a data configuration diagram of the design condition information 121.

The ground layout information 120 is information relating to ground facilities arranged on the ground of the plant, and includes ground layout drawing information 130, area information 131, equipment arrangement information 132, building arrangement information 133, and frame information 134. The ground layout drawing information 130 is information indicating a plan view for illustrating a layout of the ground facilities arranged on the ground of the plant for which a layout of underground facilities is to be designed. The ground layout drawing information 130 is extracted from, for example, two-dimensional computer-aided design (CAD) data or three-dimensional CAD data by CAD image recognition processing.

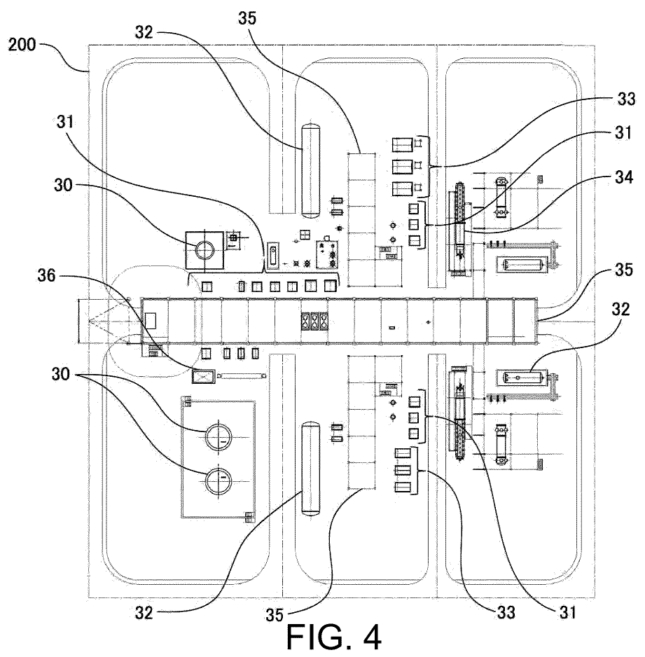

FIG. 4 is a diagram for illustrating an example of a ground layout drawing corresponding to the ground layout drawing information 130.

The plant illustrated in a ground layout drawing 200 is any plant such as a natural gas plant, an oil refinery plant, a chemical treatment plant, a power generation plant, and an iron making plant, but the plant for which the layout of the underground facilities is designed is not limited to those plants. In the plant illustrated in the ground layout drawing 200, for example, as various ground facilities for treating any liquid such as a gas, a liquid, or a powder and granular material having fluidity, tanks 30, pumps 31, drums 32, boilers 33, an exhaust heat boiler 34, pipe racks 35, an oil collection tank 36, and the like are installed to execute a predetermined manufacturing process.

The area information 131 includes attribute information indicating an attribute of a road laid in the plant and a maintenance region, and position information indicating coordinates, shapes, and sizes on the ground layout drawing 200. The equipment arrangement information 132 includes type information indicating types of the ground facilities arranged in the plant, and position information indicating coordinates, shapes, and sizes on the ground layout drawing 200. Moreover, the equipment arrangement information 132 includes drain position information indicating positions of drains into which oil is dropped from each of the ground facilities. The building arrangement information 133 includes type information of buildings such as an administrative building built in the plant, and position information indicating coordinates, shapes, and sizes of foundations and scaffolding of the buildings on the ground layout drawing 200. The frame information 134 includes type information indicating types of frames such as pipe racks arranged in the plant, and position information indicating coordinates, shapes, and sizes of foundations of support columns of the frames on the ground layout drawing 200.

The area information 131, the equipment arrangement information 132, the building arrangement information 133, and the frame information 134 may be extracted by, for example, CAD image recognition processing of two-dimensional CAD data or three-dimensional CAD data. The area information 131, the equipment arrangement information 132, the building arrangement information 133, and the frame information 134 may be extracted by using information indicating the types, the coordinates, the shapes, and the sizes of the ground facilities in addition to the CAD data. The ground layout information 120 may have, instead of the area information 131 to the frame information 134, a single piece of information obtained by converting the area information 131, the equipment arrangement information 132, the building arrangement information 133, and the frame information 134 to data and visualizing those pieces of information. The ground layout information 120 may be area information that defines areas in the plant generated based on the equipment arrangement information 132, the building arrangement information 133, and the frame information 134. The information included in the ground layout information 120 is not required to be information indicating a structure of a completed plant, and may be, for example, information that does not define sizes of all the foundations of the buildings, the support columns of the frames, and the like.

The design condition information 121 is information used in supporting design of the layout of the underground facilities of the plant, and includes water collection area information 140, separation distance information 141, interference condition information 142, intersection point information 143, and piping information 144.

The water collection area information 140 is information indicating constraint conditions when the plant is divided into a plurality of water collection areas. The water collection area information 140 includes, for example, information indicating sizes of the water collection areas, and water collection area absence region information indicating a region in which the water collection area is not arranged. The water collection area information 140 includes, for example, a maximum value of an area when the water collection area is viewed in plan view, and a maximum value of a separation distance between an outer edge of the water collection area and a water collection point that is arranged in the water collection area and collects a liquid. In the water collection area information 140, the maximum value of the area when the water collection area is viewed in plan view and the maximum value of the separation distance between the outer edge of the water collection area and the water collection point differ for each plant. The water collection area information 140 is only required to include at least one of the maximum value of the area when the water collection area is viewed in plan view or the maximum value of the separation distance between the outer edge of the water collection area and the water collection point.

The separation distance information 141 includes facility separation distance information indicating a minimum value of a separation distance between the facility such as the ground facility arranged in the plant and the water collection point, and pipe rack separation distance information indicating a minimum value of a separation distance between the pipe rack arranged in the plant and the water collection point. The separation distance corresponding to the facility separation distance information includes the separation distance between the ground facility or the foundation of the building and the support column of the frame and the water collection point. The separation distance corresponding to the pipe rack separation distance information includes the separation distance between the pipe rack and the water collection point when the plant is viewed in plan view.

The interference condition information 142 is information indicating a condition under which a plurality of pieces of piping interfere with each other. The interference condition corresponding to the interference condition information 142 includes a minimum separation distance between pieces of piping when the plant is viewed in plan view.

The intersection point information 143 is information indicating order of burial of piping at an intersection point at which pieces of piping of different systems intersect with each other. For example, the intersection point information 143 indicates that piping is buried in the underground of the plant in order of piping forming a first piping route for transporting contaminated water with which oil is mixed, piping forming a second piping route for transporting waste oil discharged from the ground facility, and piping forming a third piping route for transporting rainwater. The piping forming the first piping route is referred to also as “accidentally oily contaminated (AOC) piping.” The piping forming the second piping route is referred to also as “continuously oily contaminated (COC) piping.” The piping forming the third piping route is referred to also as “clean water sewer (CWS) piping.” In this description, the piping forming the first to third piping routes may include a ditch.

The piping information 144 includes information indicating a minimum gradient, a minimum flow velocity, a minimum piping diameter, and a minimum soil cover thickness being a minimum value of a thickness between a crown of the piping and a ground surface, regarding the piping forming each of the first piping route, the second piping route, and the third piping route. The minimum gradient of the piping forming the second piping route for transporting a liquid with a large amount of oil is higher than the minimum gradient of the piping forming the first piping route with an amount of oil smaller than an amount of oil in the piping forming the second piping route. Further, the minimum piping diameter of the piping forming the first piping route for transporting a large amount of liquid is larger than the minimum piping diameter of the piping forming the second piping route with an amount of transported liquid smaller than an amount of transported liquid in the piping forming the first piping route.

The operation unit 13 is a configuration for receiving operation executed by an operator who uses the layout design support device 1, and includes, for example, a keypad. The operation unit 13 generates a signal in accordance with the operation executed by the operator, and supplies the signal to the processing unit 20.

The display unit 14 is a configuration for displaying an image, and includes a display such as a liquid crystal display or an organic EL display. The display unit 14 generates and displays an image based on a signal supplied from the processing unit 20.

The processing unit 20 has one or a plurality of processors and a peripheral circuit thereof. The processing unit 20 integrally controls overall operation of the layout design support device 1, and is, for example, a CPU. The processing unit 20 executes processing based on the program (driver program, operating system program, application program, or the like) stored in the storage unit 12. The processing unit 20 can execute a plurality of programs (application programs and the like) in parallel.

The processing unit 20 includes an information acquisition module 21, a generation module 22, and an output module 23. The information acquisition module 21, the generation module 22, and the output module 23 are functional modules implemented by programs executed by the processor included in the processing unit 20. Alternatively, the information acquisition module 21, the generation module 22, and the output module 23 may be implemented as firmware in the layout design support device 1.

### Layout Design Support Processing Executed by Layout Design Support Device According to Embodiment

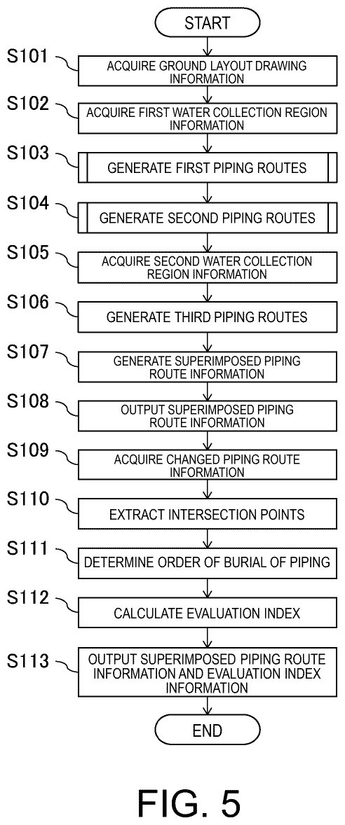

FIG. 5 is a flowchart of the layout design support processing executed by the layout design support device 1. The layout design support processing illustrated in FIG. 5 is executed mainly by the processing unit 20 in cooperation with each element in the layout design support device 1 based on the program stored in the storage unit 12 in advance.

First, the information acquisition module 21 acquires the ground layout drawing information 130 relating to a layout of the ground facilities arranged on the ground of the plant based on a ground layout information transmission instruction input from the designer terminal device 101 (Step S101). The information acquisition module 21 acquires the ground layout drawing information 130 from the storage unit 12. The information acquisition module 21 outputs the ground layout drawing information 130 acquired from the storage unit 12 to the designer terminal device 101 that has output the ground layout information transmission instruction.

Subsequently, the information acquisition module 21 acquires first water collection region information indicating a first water collection region (Step S102). The designer terminal device 101 to which the ground layout drawing information 130 has been input displays the ground layout drawing corresponding to the ground layout drawing information 130 on the terminal display unit 114. A designer specifies the first water collection region by rendering the first water collection region superimposed on the ground layout drawing displayed on the terminal display unit 114, and instructs the designer terminal device 101 to transmit the first water collection region information indicating the specified first water collection region. The designer terminal device 101 outputs the first water collection region information to the layout design support device 1 in accordance with the instruction made by the designer. In response to input of the first water collection region information from the designer terminal device 101, the information acquisition module 21 acquires the input first water collection region information.

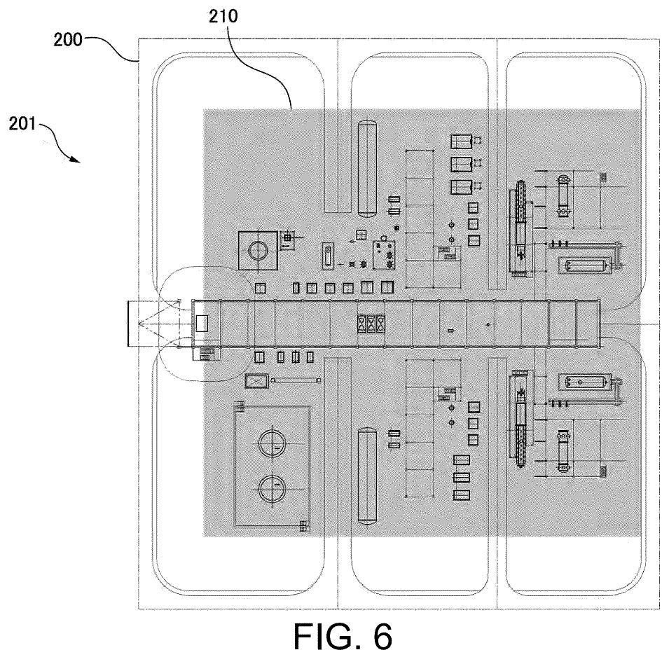

FIG. 6 is a diagram for illustrating an image in which the first water collection region corresponding to the first water collection region information is superimposed on the ground layout drawing corresponding to the ground layout drawing information 130 acquired in the processing step of Step S101. The image illustrated in FIG. 6 is displayed on the terminal display unit 114 of the designer terminal device 101 to which the ground layout drawing information 130 has been input.

An image 201 includes the ground layout drawing 200 and a first water collection region image 210 arranged to be superimposed on the ground layout drawing 200. The ground layout drawing 200 is an image corresponding to the ground layout drawing information 130. The first water collection region image 210 is rendered to be superimposed on the ground layout drawing 200, by the designer through the terminal operation unit 113. The first water collection region information indicating the first water collection region image 210 is output to the layout design support device 1 in accordance with an instruction made by the designer.

The first water collection region corresponding to the first water collection region image 210 is a region including facilities arranged in the plant, and is a region in which contaminated water arising from mixing of oil discharged or leaked out from the ground facilities arranged in the plant with water, such as rainwater or fire extinguishing wastewater, is collected.

Subsequently, based on the ground layout information 120 and the design condition information 121, the generation module 22 generates positions of a plurality of water collection points and a plurality of first piping routes being piping routes along which piping that discharges, from the plant, a liquid collected into the plurality of water collection points is buried in the underground of the plant (Step S103). Each of the plurality of water collection points is arranged on the ground surface of the plant, and the liquid is collected into the water collection point from the ground of the plant.

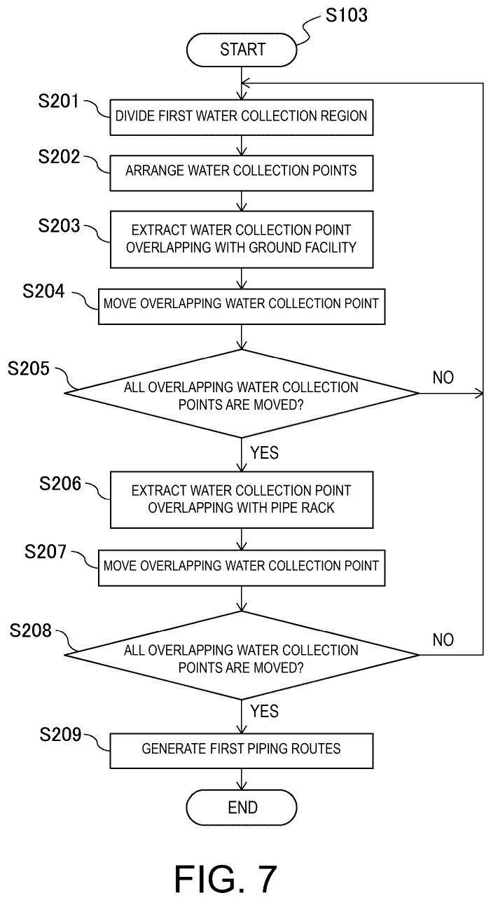

FIG. 7 is a flowchart for illustrating more detailed processing of the processing step of Step S103.

First, the generation module 22 divides the first water collection region corresponding to the first water collection region information acquired in the processing step of Step S102 into a plurality of water collection areas (Step S201). The generation module 22 refers to the water collection areas in the design condition information 121 stored in the storage unit 12, and acquires the constraint conditions of the water collection area and the water collection area absence region information indicating the region in which the water collection area is not arranged.

Subsequently, the generation module 22 arranges water collection points referred to also as “catch basin” at the centers of the water collection areas obtained by the dividing in the processing step of Step S201 (Step S202). When the water collection point has a rectangular planar shape, the generation module 22 arranges the water collection point at an intersection of diagonals of the water collection point. When the water collection point has a planar shape other than a rectangle, the generation module 22 arranges the water collection point at a centroid of the water collection point. The generation module 22 stores coordinates of the arranged water collection points in the storage unit 12.

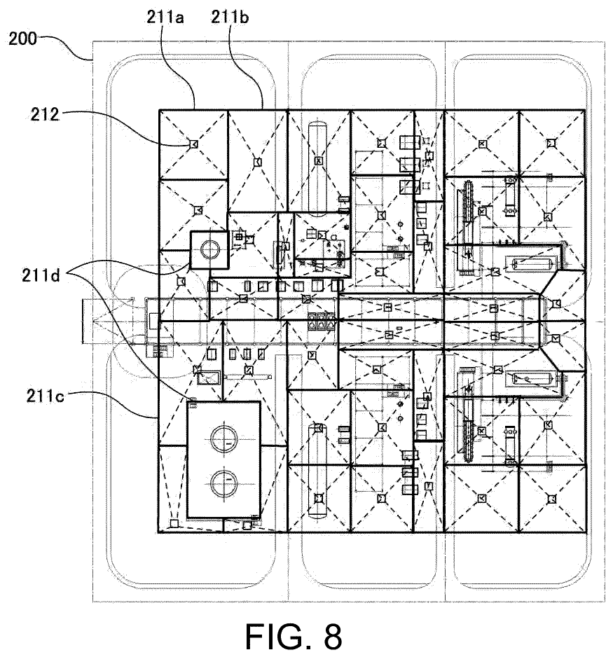

FIG. 8 is an explanatory diagram for illustrating the processing steps of Step S201 and Step S202. In FIG. 8, a plurality of water collection areas 211 are arranged on the ground layout drawing 200, and a water collection point 212 is arranged at the center of each of the plurality of water collection areas 211.

The single water collection point 212 is arranged in each of the plurality of water collection areas 211. An inclined surface gradually inclined downward from an outer edge toward the water collection point 212 is formed in each of the plurality of water collection areas 211, and collects, as contaminated water into the water collection point 212, oil leaked from the ground facility arranged in the water collection area 211, together with water such as rainwater. The water collection point 212 receives the contaminated water that has flowed down on the inclined surface of the water collection area 211. An inclination angle of the inclined surface formed in the water collection area 211 is, for example, 1%.

A water collection area 211a has a square planar shape. A water collection area 211b has a rectangular planar shape. A water collection area 211c has an inverted L planar shape. Areas of the water collection areas 211a, 211, and 211c are equal to or smaller than the maximum area defined in the water collection area information 140. A half value of a diagonal of the water collection areas 211a and 211b is equal to or shorter than the maximum separation distance defined in the water collection area information 140. A separation distance from a centroid and a corner most separate from the centroid in the water collection area 211c is equal to or shorter than the maximum separation distance defined in the water collection area information 140. The water collection area 211 and the water collection point 212 are not arranged in a water collection area absence region 211d.

Subsequently, the generation module 22 extracts the water collection point 212 arranged to overlap with the ground facility from the water collection points 212 arranged in the processing step of Step S202 (Step S203). The generation module 22 extracts facility regions being regions in which the ground facility is arranged, from the position information included in the equipment arrangement information 132 of the ground layout information 120 and the separation distance between the ground facility and the water collection point defined in the separation distance information 141. The facility region is an example of a prohibition region in which the water collection point is prohibited from being arranged. The generation module 22 compares the coordinates of each of the water collection points 212 arranged in the processing step of Step S202 with the extracted facility regions, and determines whether or not the coordinates of the water collection point 212 are included in the facility region. When the coordinates of the water collection point 212 are included in the facility region, the generation module 22 determines that the water collection point 212 is arranged to overlap with the ground facility. When the generation module 22 determines that the water collection point 212 is arranged to overlap with the ground facility, the generation module 22 stores the water collection point 212 arranged to overlap with the ground facility, in the storage unit 12. Meanwhile, when the coordinates of the water collection point 212 are not included in coordinates of the facility region, the generation module 22 determines that the water collection point 212 is not arranged to overlap with the ground facility.

Subsequently, the generation module 22 moves the water collection point 212 arranged to overlap with the ground facility, to a position that does not overlap with the facility region (Step S204). There is a fear of fire occurrence at the water collection point 212 depending on the kind of liquid treated in the plant. In addition, it is desired to facilitate maintenance and management such as dust removal for the water collection point 212. Thus, it is not preferred that the water collection point 212 be arranged under the ground facility. The storage unit 12 moves the water collection point 212 determined to be arranged to overlap with the ground facility in the processing step of Step S203, to the outside of the facility region. The separation distance between the water collection point 212 and the facility region is determined depending on the liquid treated in the plant and the kind of ground facility deemed as a subject, and is defined in the design condition information 121.

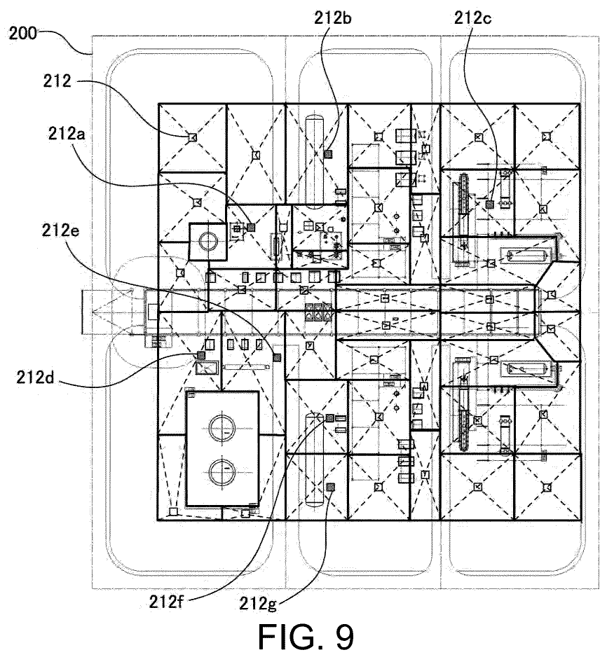

FIG. 9 is an explanatory diagram for illustrating the processing step of Step S204. In FIG. 9, water collection points 212a to 212g moved in the processing step of Step S204 are illustrated as solid points, and are different, in a display form, from other water collection points 212 that are illustrated as open points and are not moved in the processing step of Step S204. Each of the water collection points 212a to 212g moves to a position that does not overlap with the facility region in which the ground facility arranged in the plant is arranged, by the processing step of Step S204.

Subsequently, the generation module 22 determines whether or not all the water collection points 212 arranged to overlap with the ground facility have successfully been moved to the outside of the facility region (Step S205). When the water collection point 212 that cannot be moved to the outside of the facility region does not exist, the generation module 22 determines that all the water collection points 212 have successfully been moved to the outside of the facility region (YES in Step S205). Meanwhile, when the water collection point 212 that does not satisfy the constraint conditions defined in the water collection area information 140 and cannot be moved to the outside of the facility region exists, the generation module 22 determines that not all the water collection points 212 can be moved to the outside of the facility region (NO in Step S205).

The process returns to Step S201 when it is determined by the generation module 22 that not all the water collection points 212 can be moved to the outside of the facility region (NO in Step S205). From then on, the processing steps of from Step S201 to Step S205 are repeated until it is determined by the generation module 22 that all the water collection points 212 can be moved to the outside of the facility region (YES in Step S205).

When the generation module 22 determines that all the water collection points 212 can be moved to the outside of the facility region (YES in Step S205), the generation module 22 extracts the water collection point 212 arranged to overlap with the pipe rack (Step S206). The generation module 22 extracts pipe rack regions being regions in which the pipe rack is arranged, from the type information and the position information included in the frame information 134 of the ground layout information 120, and the separation distance between the pipe rack and the water collection point defined in the separation distance information 141. The pipe rack region is another example of the prohibition region in which the water collection point is prohibited from being arranged. The generation module 22 compares the coordinates of each of the water collection points 212 with the extracted pipe rack regions, and determines whether or not the coordinates of the water collection point 212 are included in the pipe rack region. When the coordinates of the water collection point 212 are included in the pipe rack region, the generation module 22 determines that the water collection point 212 is arranged to overlap with the pipe rack. When the generation module 22 determines that the water collection point 212 is arranged to overlap with the pipe rack facility, the generation module 22 stores the water collection point 212 arranged to overlap with the pipe rack facility, in the storage unit 12. Meanwhile, when the coordinates of the water collection point 212 are not included in coordinates of the pipe rack region, the generation module 22 determines that the water collection point 212 is not arranged to overlap with the pipe rack.

Subsequently, the generation module 22 moves the water collection point 212 arranged to overlap with the pipe rack, to a position that does not overlap with the pipe rack region (Step S207). There is a fear of fire occurrence at the water collection point 212 depending on the kind of liquid treated in the plant. Thus, it is not preferred that the water collection point 212 be arranged under the pipe rack that transports a flammable liquid. The storage unit 12 moves the water collection point 212 determined to be arranged to overlap with the pipe rack in the processing step of Step S206, to the outside of the pipe rack region. The separation distance between the water collection point 212 and the pipe rack region is determined depending on the liquid treated in the plant.

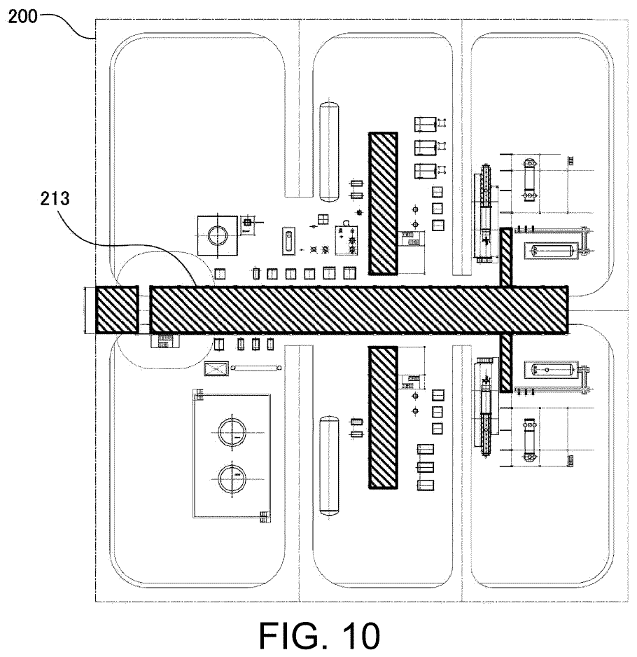

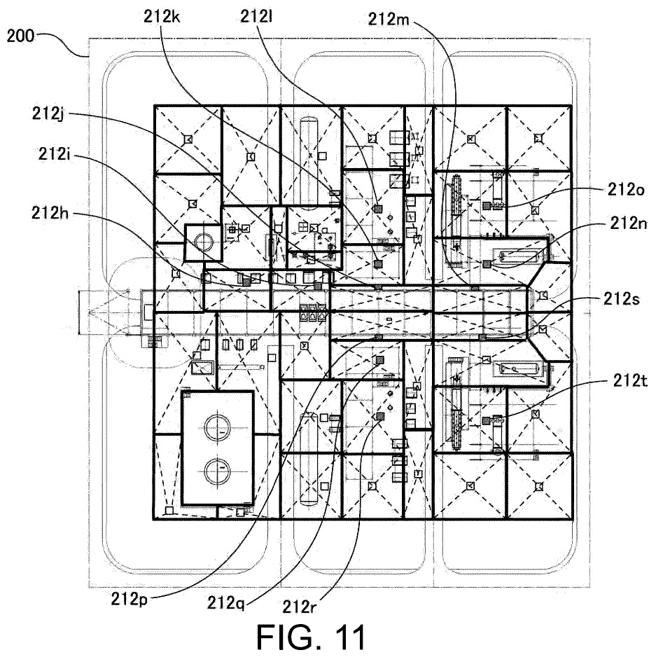

FIG. 10 and FIG. 11 are explanatory diagrams for illustrating the processing step of Step S207. In FIG. 10, a pipe rack region 213 is illustrated with hatching. In FIG. 11, water collection points 212h to 212t moved in the processing step of Step S207 are illustrated as solid points, and are different, in a display form, from other water collection points 212 that are illustrated as open points and are not moved in the processing step of Step S207. The pipe rack region 213 is extracted from the type information and the position information included in the frame information 134 of the ground layout information 120. Each of the water collection points 212h to 212t moves to a position that does not overlap with the pipe rack region 213, by the processing step of Step S207.

Subsequently, the generation module 22 determines whether or not all the water collection points 212 arranged to overlap with the pipe rack have successfully been moved to the outside of the pipe rack region (Step S208). When the water collection point 212 that cannot be moved to the outside of the pipe rack region does not exist, the generation module 22 determines that all the water collection points 212 have successfully been moved to the outside of the pipe rack region (YES in Step S208). Meanwhile, when the water collection point 212 that does not satisfy the constraint conditions defined in the water collection area information 140 and cannot be moved to the outside of the pipe rack region exists, the generation module 22 determines that not all the water collection points 212 can be moved to the outside of the pipe rack region (NO in Step S208).

The process returns to Step S201 when it is determined by the generation module 22 that not all the water collection points 212 can be moved to the outside of the pipe rack region (NO in Step S208). From then on, the processing steps of from Step S201 to Step S208 are repeated until it is determined by the generation module 22 that all the water collection points 212 can be moved to the outside of the pipe rack region (YES in Step S208).

Subsequently, when the generation module 22 determines that all the water collection points 212 can be moved to the outside of the pipe rack region (YES in Step S208), the generation module 22 generates the first piping routes being piping routes along which piping that discharges, from the plant, the liquid collected into the water collection points 212 is buried in the underground of the plant (Step S209). The generation module 22 generates a plurality of first piping routes by using a publicly-known pathfinding algorithm such as the Dijkstra's algorithm, and stores, in the storage unit 12, first piping route information indicating each of the plurality of first piping routes generated, and the processing step of Step S103 ends.

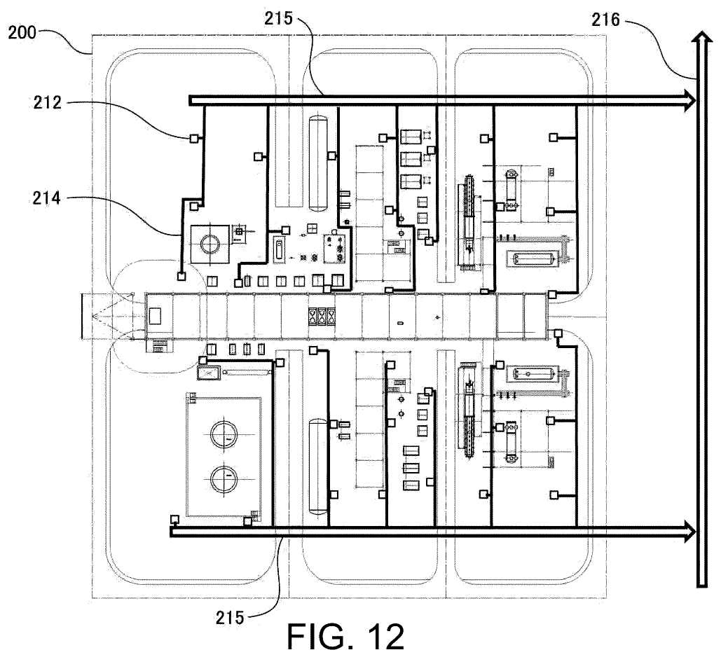

FIG. 12 is an explanatory diagram for illustrating the processing step of Step S209. In FIG. 12, each of the plurality of water collection points 212 is connected to external piping 216 through a plurality of pieces of piping 214 and a pair of pieces of main piping 215 arranged along an outer edge of the first water collection region. The generation module 22 refers to the ground layout information 120 and the design condition information 121, and arranges the plurality of pieces of piping 214 such that the plurality of pieces of piping 214 do not overlap with the foundation, the scaffolding, and the like of the building. Each of the plurality of water collection points 212 may be connected to the external piping 216 through main piping arranged at a central part of the first water collection region instead of the pair of pieces of main piping 215.

When the processing step of Step S103 ends, the generation module 22 generates a plurality of second piping routes being piping routes along which piping that connects a plurality of oil collection points to an oil collection tank is buried in the underground of the plant, based on the ground layout information 120 and the design condition information 121 (Step S104). Each of the plurality of oil collection points is arranged on the ground surface of the plant, and oil that drops from the ground facility arranged in the plant is collected into the oil collection point. The oil collection tank houses the oil collected into the oil collection points.

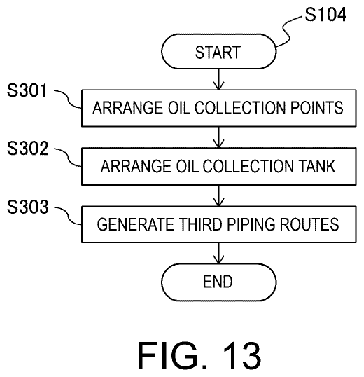

FIG. 13 is a flowchart for illustrating more detailed processing of the processing step of Step S104.

First, the generation module 22 arranges a plurality of oil collection points in the first water collection region (Step S301). The generation module 22 acquires the drain position information indicating the positions of the drains into which oil is dropped from each of the ground facilities, from the equipment arrangement information 132 stored in the storage unit 12. The generation module 22 arranges each of the plurality of oil collection points at the position corresponding to the acquired drain position information.

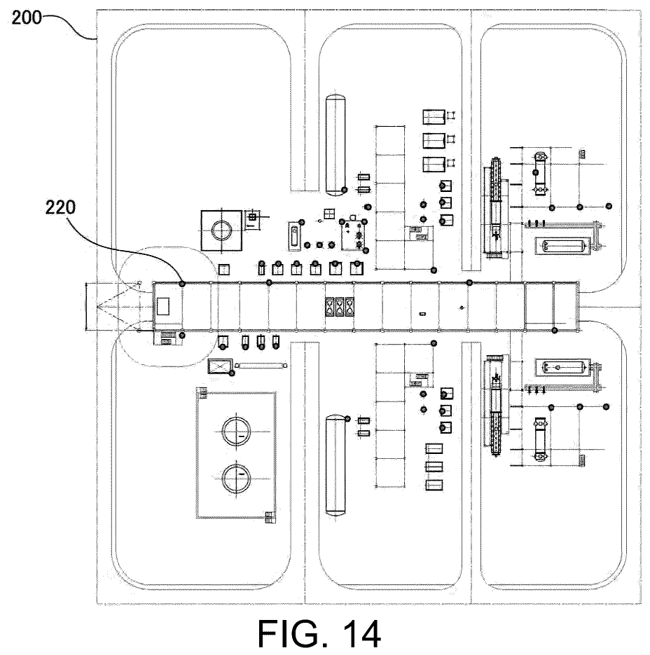

FIG. 14 is an explanatory diagram for illustrating the processing step of Step S301. In FIG. 14, oil collection points 220 are illustrated as solid points. Each of the plurality of oil collection points 220 is arranged at a position corresponding to the position of the drain for the ground facility arranged in the first water collection region. Each of the plurality of oil collection points is arranged directly under the drain for the ground facility by being arranged at the position corresponding to the drain position information.

Subsequently, the generation module 22 arranges the oil collection tank that houses the oil collected into the plurality of oil collection points (Step S302). The generation module 22 refers to the equipment arrangement information 132 stored in the storage unit 12, and acquires oil collection tank position information indicating a position of the oil collection tank. The generation module 22 arranges the oil collection tank at a position corresponding to the acquired oil collection tank position information. When the equipment arrangement information 132 does not include the oil collection tank position information, the generation module 22 may arrange the oil collection tank in accordance with an instruction made by the designer through the designer terminal device 101.

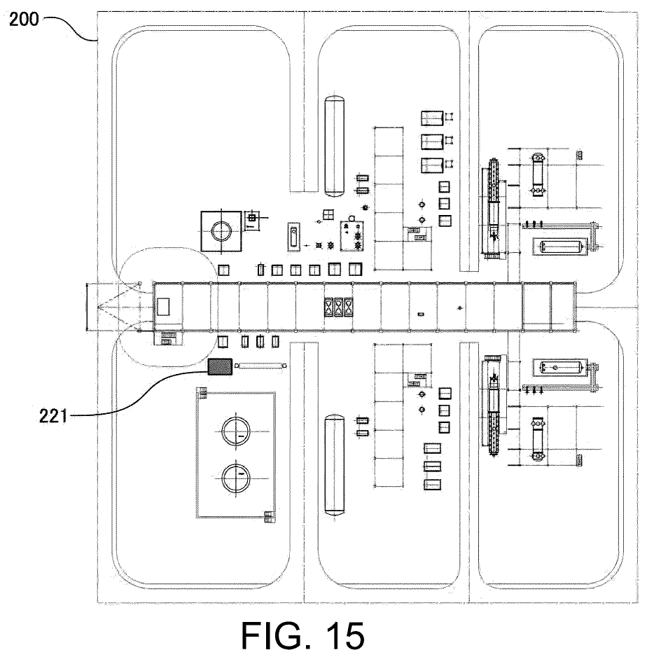

FIG. 15 is an explanatory diagram for illustrating the processing step of Step S302. In FIG. 15, an oil collection tank 221 is illustrated as a solid area. The oil collection tank 221 has a rectangular planar shape, and is arranged inside the first water collection region.

Subsequently, the generation module 22 generates the second piping routes being piping routes along which piping that connects the plurality of oil collection points 220 to the oil collection tank 221 that houses the oil collected into the oil collection points 220 is buried in the underground of the plant (Step S303). The generation module 22 generates a plurality of third piping routes by using a publicly-known pathfinding algorithm such as the Dijkstra's algorithm, and stores, in the storage unit 12, second piping route information indicating each of the plurality of second piping routes generated, and the processing step of Step S104 ends.

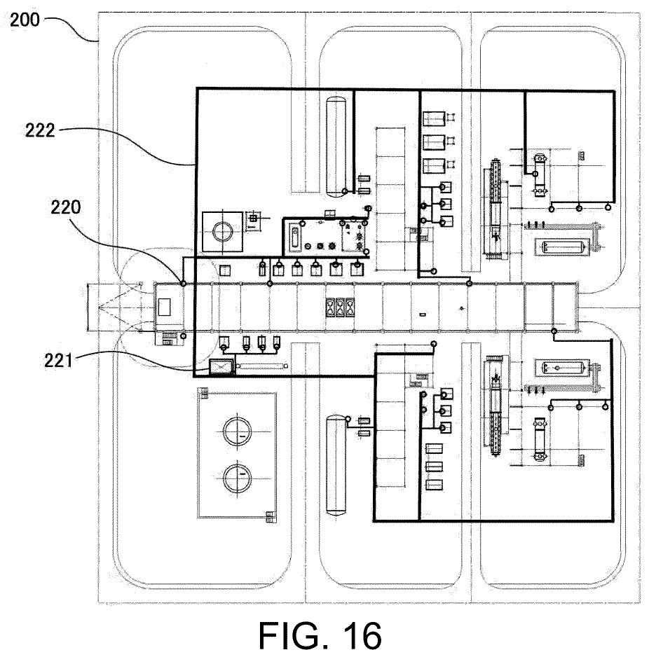

FIG. 16 is an explanatory diagram for illustrating the processing step of Step S303. In FIG. 16, each of the oil collection points 220 is connected to the oil collection tank 221 through a plurality of pieces of piping 222 extending among the ground facilities. The generation module 22 refers to the ground layout information 120 and the design condition information 121, and arranges the plurality of pieces of piping 222 such that the plurality of pieces of piping 222 do not overlap with the foundation, the scaffolding, and the like of the building.

When the processing step of Step S104 ends, the information acquisition module 21 acquires second water collection region information indicating a second water collection region (Step S105). In response to input of the second water collection region information from the designer terminal device 101 that has output the ground layout information transmission instruction, the information acquisition module 21 acquires the input second water collection region information.

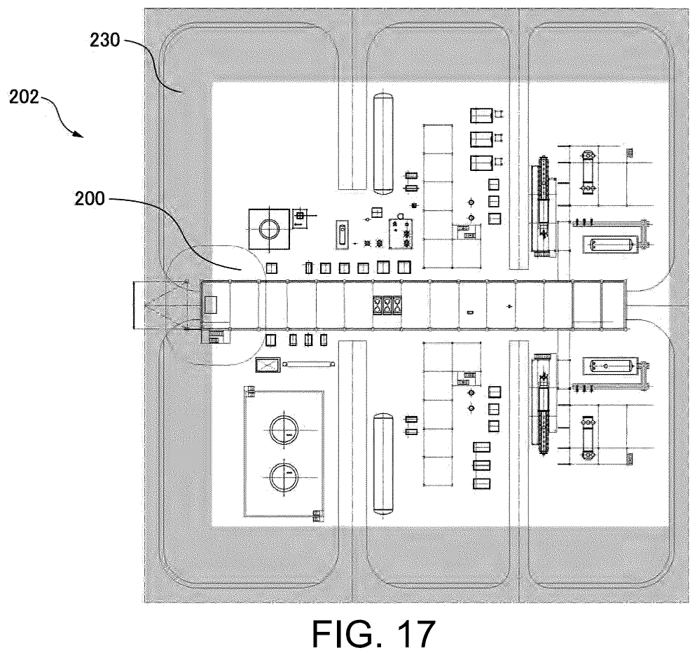

FIG. 17 is a diagram for illustrating an image in which the second water collection region corresponding to the second water collection region information is superimposed on the ground layout drawing corresponding to the ground layout drawing information 130 acquired in the processing step of Step S101. The image illustrated in FIG. 13 is displayed on the terminal display unit 114 of the designer terminal device 101 to which the ground layout drawing information 130 has been input.

An image 202 includes the ground layout drawing 200 and a second water collection region image 230 arranged to be superimposed on the ground layout drawing 200. Similarly to the first water collection region image 210, the second water collection region image 230 is rendered to be superimposed on the ground layout drawing 200, by the designer through the terminal operation unit 113. The second water collection region information indicating the second water collection region image 230 is output to the layout design support device 1 in accordance with an instruction made by the designer.

The second water collection region corresponding to the second water collection region image 230 is a region that is arranged outside the first water collection region and surrounds the first water collection region, and is a region in which, for example, water such as rainwater, with which oil discharged or leaked out from facilities arranged in the plant is not mixed, is collected.

Subsequently, the generation module 22 generates a plurality of third piping routes being piping routes along which piping that discharges a liquid from the second water collection region outside the first water collection region is buried in the underground of the plant, based on the ground layout information 120 and the design condition information 121 (Step S106). The generation module 22 generates the plurality of third piping routes by using a publicly-known pathfinding algorithm such as the Dijkstra's algorithm, and stores, in the storage unit 12, third piping route information indicating each of the plurality of third piping routes generated.

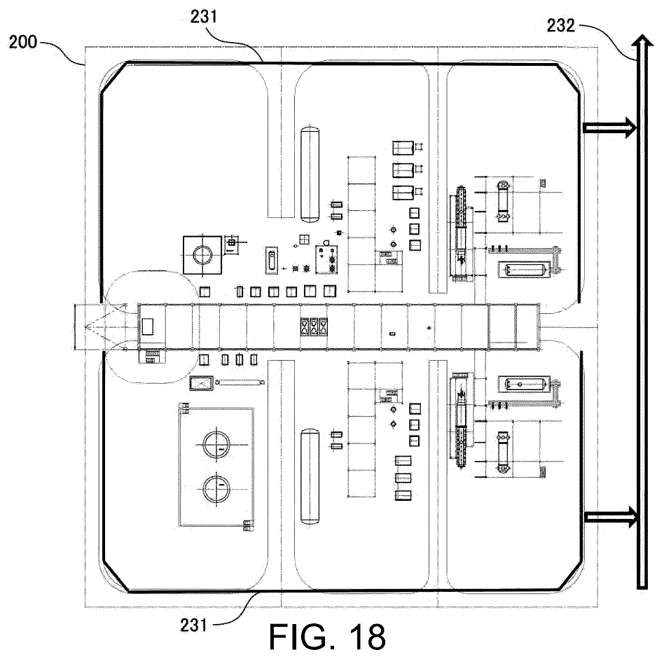

FIG. 18 is an explanatory diagram for illustrating the processing step of Step S105. In FIG. 18, each of a pair of pieces of third piping 231 is arranged along an outer edge of the plant to surround the ground facilities arranged in the plant, and is connected to external piping 232.

Subsequently, the generation module 22 generates a plurality of superimposed piping routes each obtained by superimposing one of the plurality of first piping routes, one of the plurality of second piping routes, and one of the plurality of third piping routes, the first piping routes, the second piping routes, and the third piping routes having been generated in the processing steps of Step S103, Step S104, and Step S106, respectively (Step S107). When the generation module 22 combines each of the first piping route, the second piping route, and the third piping route, the generation module 22 generates the wiring routes to be combined, based on a predetermined parameter such as a total length of the piping routes. The generation module 22 stores, in the storage unit 12, superimposed piping route information indicating the generated superimposed piping route in association with an identification number. The number of superimposed piping routes generated by the generation module 22 is generated as appropriate depending on a size of the plant, or the like.

Subsequently, the generation module 22 extracts an interference region in which the first piping route, the second piping route, and the third piping route included in the plurality of superimposed piping routes generated in the processing step of Step S107 interfere with each other (Step S108). The generation module 22 refers to the interference condition information 142 of the design condition information 121 stored in the storage unit 12, and acquires the interference condition indicating that the first piping route, the second piping route, and the third piping route interfere with each other. The generation module 22 determines whether or not the pieces of piping included in the first piping route, the second piping route, and the third piping route interfere with each other, by using the acquired interference condition. When the generation module 22 determines that the pieces of piping interfere with each other, the generation module 22 extracts the interference region including the pieces of piping determined to interfere with each other, and stores interference region information indicating the extracted interference region, in the storage unit 12.

Subsequently, the output module 23 outputs, to the designer terminal device 101, the superimposed piping route information together with the identification number associated with the superimposed piping route information, the ground layout drawing information 130, and the interference region information (Step S108). In response to input of the superimposed piping route information, the ground layout information, and the interference region information, the designer terminal device 101 displays the first piping route to the third piping route on the terminal display unit 114 such that those piping routes are superimposed on the ground layout and the interference region.

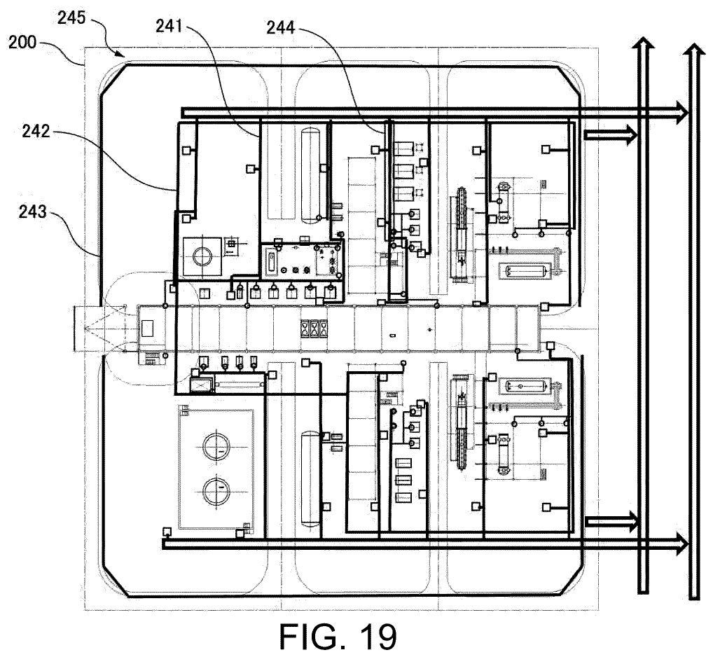

FIG. 19 is a diagram for illustrating an image displayed on the terminal display unit 114 of the designer terminal device 101 in accordance with the processing step of Step S108.

In FIG. 19, a superimposed piping route 245 including a first piping route 241, a second piping route 242, and a third piping route 243 is displayed to be superimposed on the ground layout drawing 200. Further, an interference region 244 is displayed to be superimposed on the ground layout drawing 200. The designer determines whether or not interference in the interference region 244 displayed on the terminal display unit 114 becomes a problem in terms of construction of the plant. When the designer determines that the interference in the interference region 244 becomes a problem in terms of construction of the plant, the designer moves an arrangement of the piping so as to solve the interference in the interference region 244. The designer terminal device 101 stores changed piping route information indicating a changed piping route obtained by moving the arrangement of the piping from the superimposed piping route so as to solve the interference, in association with the identification number of the superimposed piping route information before the change.

Subsequently, the information acquisition module 21 acquires the changed piping route information from the designer terminal device 101 (Step S109). In accordance with an instruction made by the designer, the designer terminal device 101 outputs the changed piping route information in association with identification information to the layout design support device 1. The information acquisition module 21 acquires the input changed piping route information, and stores, in the storage unit 12, the acquired changed piping route information as the superimposed piping route information associated with the identification information.

Subsequently, the generation module 22 extracts the intersection points at which the pieces of piping included in the first piping route 241, the second piping route 242, and the third piping route 243 in the superimposed piping route intersect with each other (Step S110). The generation module 22 extracts the intersection point in the superimposed piping route corresponding to each of a plurality of pieces of superimposed piping route information, and stores coordinates of the extracted intersection point in association with the same identification information as that of the superimposed piping route information. Moreover, the generation module 22 stores the number of extracted intersection points.

Subsequently, the generation module 22 determines order of burial of piping at the intersection points (Step S111). The generation module 22 refers to the intersection point information 143 of the design condition information 121 stored in the storage unit 12, and determines the order of burial of the piping included in the first piping route 241 to the third piping route 243 for each of the intersection points extracted in the processing step of Step S110. The generation module 22 stores, in the storage unit 12, the determined order of burial of the piping in association with an intersection point identifier for identifying the intersection point.

Subsequently, the generation module 22 calculates, for each of the plurality of superimposed piping routes, an evaluation index for evaluating constructability of construction of burying the underground facility including the piping in the underground of the plant (Step S112). The evaluation index calculated by the generation module 22 includes, for example, a total length of the first piping route 241, the second piping route 242, and the third piping route 243, a depth of flow end piping of the first piping route 241, the second piping route 242, and the third piping route 243, and an amount of excavated earth. Further, the evaluation index includes the number of intersection points extracted in the processing step of Step S110. The generation module 22 stores the calculated evaluation index in association with an identifier in the storage unit 12.

Then, the information acquisition module 21 outputs, to the designer terminal device 101, the plurality of pieces of superimposed piping route information stored in the storage unit 12 and evaluation index information indicating the evaluation index corresponding to the superimposed piping route information, together with the ground layout drawing information 130 (Step S113).

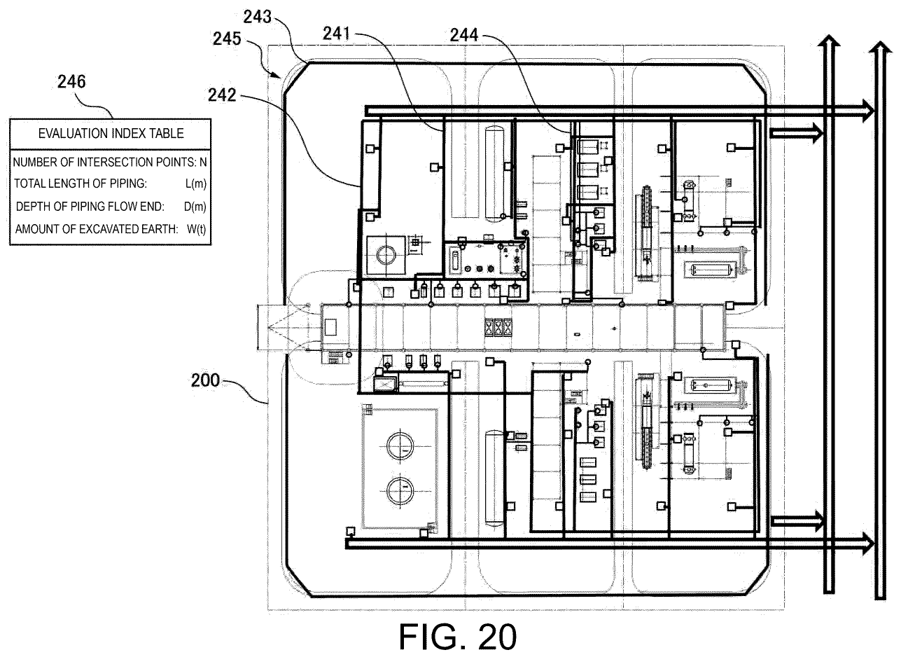

FIG. 20 is a diagram for illustrating an image displayed on the terminal display unit 114 of the designer terminal device 101 in accordance with the processing step of Step S112.

In FIG. 20, the superimposed piping route 245 including the first piping route 241 to the third piping route 243 is displayed to be superimposed on the ground layout drawing 200. In addition, an evaluation index table 246 is displayed beside the ground layout drawing 200 and the superimposed piping route 245. The evaluation index table 246 displays “the number of intersection points,” “total length of piping,” “depth of piping flow end,” and “the amount of excavated earth” as the evaluation index. The designer determines whether the constructability of construction is excellent for a plurality of superimposed piping routes 245 based on the evaluation index described in the evaluation index table 246, and employs the superimposed piping route 245 determined to be the most excellent. For example, in a case in which a bedrock layer exists at a depth of several meters or more from the ground at a planned construction site of a plant, the designer selects the superimposed piping route with which the depth of the flow end piping is shallow and a depth of excavation is shallow.

### Actions and Effects of Layout Design Support Device According to Embodiment

The layout design support device 1 can increase efficiency of layout design of the underground facilities by automatically generating the positions of the plurality of water collection points 212, and the first piping route including the plurality of pieces of piping 214, based on the ground layout information 120 and the design condition information 121. Further, the layout design support device 1 can reduce a burden of the layout design of the underground facilities involving many experiential factors, by automatically generating the first piping route.

Moreover, the layout design support device 1 determines the positions of the water collection points 212 by using the design condition information 121 including information indicating the size of the water collection area 211, to thereby enable suppression of occurrence of a trouble such as remaining of contaminated water with which oil is mixed on a ground surface of the plant for a long time.

In addition, the layout design support device 1 can suppress a time for which the contaminated water remains to a desired time or shorter by determining the positions of the water collection points 212 by using the area of the water collection area 211 and the maximum value of the separation distance between the outer edge of the water collection area 211 and the water collection point 212.

Further, the layout design support device 1 arranges the water collection point 212 at the center of the water collection area 211, and thus can minimize the separation distance between the outer edge of the water collection area 211 and the water collection point 212, and can maximize the area of the water collection area 211. The layout design support device 1 can minimize the number of water collection points 212 arranged, by minimizing the separation distance between the outer edge of the water collection area 211 and the water collection point 212, and maximizing the area of the water collection area 211.

Moreover, with the layout design support device 1, the water collection point 212, into which the contaminated water with which oil is mixed is collected, is not arranged in regions in which the ground facility and the pipe rack are arranged. Thus, occurrence of an accident such as a fire in the plant can be suppressed, and maintenance and inspection of the water collection point 212 becomes easier.

In addition, with the layout design support device 1, oil dropped from the drains for the ground facilities is recovered through the second piping route different from the first piping route. Thus, the amount of oil contained in the contaminated water that flows into the first piping route can be minimized.

Further, the layout design support device 1 allows display of the interference region, in which the pieces of piping forming the first piping route to the third piping route interfere with each other, such that the designer can visually recognize the interference region. Thus, the designer can easily correct the position of the interfering piece of piping.

Moreover, the layout design support device 1 generates the plurality of superimposed piping routes, and allows display of the plurality of superimposed piping routes generated, such that the designer can visually recognize the superimposed piping routes. Thus, the designer can select the superimposed piping route with high constructability from the plurality of superimposed piping routes.

In addition, the layout design support device 1 allows display of the evaluation index for evaluating the constructability of construction of burying the underground facilities, together with the plurality of superimposed piping routes such that the designer can visually recognize the evaluation index and the superimposed piping routes. Thus, the designer can easily select the superimposed piping route with high constructability from the plurality of superimposed piping routes.

### Modification Examples of Layout Design Support Device According to Embodiment

The layout design support device 1 generates the first piping route to the third piping route, but the layout design support device according to the embodiment may generate only the first piping route for transporting the contaminated water with which oil is mixed. Alternatively, the layout design support device according to the embodiment may generate the first piping route for transporting the contaminated water with which oil is mixed, and the second piping route for transporting the waste oil discharged from upper facilities, without generating the third piping route for transporting rainwater with which oil is not mixed.

Further, the layout design support device 1 employs the facility region in which the ground facility is arranged and the pipe rack region in which the pipe rack is arranged, as the prohibition region, but the layout design support device according to the embodiment may employ a region other than the facility region and the pipe rack region, as the prohibition region. For example, the layout design support device according to the embodiment may employ a region in which the foundation and the scaffolding of the building are arranged, as the prohibition region, or may employ a region in which the foundation of the support column of the frame is arranged, as the prohibition region.

Moreover, the layout design support device 1 regards the region in which the pieces of piping forming the first piping route to the third piping route interfere with each other, as the interference region, but the layout design support device according to the embodiment may regard a region in which piping interferes with the underground facility other than the piping, as the interference region.

For example, the layout design support device according to the embodiment may regard, as the interference region, a region in which the piping interferes with a cable route along which at least one of a power cable for supplying electric power to the ground facility or an instrumentation cable connected to an instrumentation facility used for control of the ground facility is buried in the underground of the plant. The information acquisition module 21 acquires cable route information indicating the cable route along which at least one of the power cable or the instrumentation cable is buried in the underground of the plant. The generation module 22 extracts, as the interference region, a region in which an indicating cable route corresponding to indicating cable route information acquired by the information acquisition module 21 interferes with the piping included in the first piping route to the third piping route. The output module outputs, to the designer terminal device 101, the interference region information indicating the interference region in which the cable route and the piping interfere with each other.

In addition, the layout design support device 1 outputs the evaluation index information together with the superimposed piping route information, but the layout design support device according to the embodiment may output pieces of information such as an alert relating to the layout of the ground facilities and a comment that encourages relocation of the ground facility, together with the evaluation index information. Alternatively, the layout design support device according to the embodiment may output the pieces of information such as the alert relating to the layout of the ground facilities and the comment that encourages relocation of the ground facility, instead of the evaluation index information. For example, the generation module 22 extracts a high density region being a region in which the density per unit area of the piping included in the superimposed piping route 245 is high, and the output module 23 outputs an alert signal indicating the existence of the high density region. Alternatively, the generation module 22 extracts the high density region being a region in which the density per unit area of the piping included in the superimposed piping route 245 is high, and the output module 23 outputs information indicating a comment that encourages relocation of the ground facility arranged near the high density region.

Further, with the layout design support device 1, the water collection area absence region 211d in which the water collection area 211 and the water collection point 212 are not arranged exists, but the water collection area absence region 211d may have the water collection point 212. For example, the water collection point 212 arranged in the water collection area absence region 211d may be arranged at a corner of the water collection point 212. When the water collection point 212 is arranged at a corner of the water collection point 212, an inclined surface gradually inclined downward from an outer edge of the water collection area absence region 211d toward the corner at which the water collection point 212 is formed is formed in the water collection area absence region 211d.

Moreover, with the layout design support device 1, the water collection point 212 is arranged near the center of the water collection area 211, but, with the layout design support device according to the embodiment, the water collection point 212 may be arranged at any point in the water collection area 211.

In addition, with the layout design support device 1, the pieces of piping forming the first piping route to the third piping route transport the contaminated water with which oil is mixed, the waste oil, and the rainwater, respectively, but, with the layout design support device according to the embodiment, each of the pieces of piping forming the first piping route to the third piping route is only required to be piping that transports a liquid.

1. A layout design support device for supporting design of a layout of underground facilities buried in underground of a plant, the layout design support device comprising:
an information acquisition module configured to acquire ground layout information relating to a layout of ground facilities arranged on ground of the plant, and design condition information relating to design of the underground facilities;
a generation module configured to generate, based on the ground layout information and the design condition information, positions of a plurality of water collection points into which a liquid is collected from the ground of the plant, and a first piping route along which piping that discharges, from the plant, the liquid collected into the plurality of water collection points is buried in the underground of the plant; and
an output module configured to output underground layout information indicating the positions of the plurality of water collection points and the first piping route.

2. The layout design support device according to claim 1, wherein the design condition information includes information indicating a size of a water collection area in which the liquid is collected into each of the plurality of water collection points.

3. The layout design support device according to claim 2, wherein the size of the water collection area includes at least one of a maximum value of an area when the water collection area is viewed in plan view or a maximum value of a separation distance between an outer edge of the water collection area and one of the plurality of water collection points.

4. The layout design support device according to claim 1, wherein the generation module is configured to:
divide a first water collection region of the plant into a plurality of water collection areas; and
arrange each of the plurality of water collection points at a center of one of the plurality of water collection areas.

5. The layout design support device according to claim 4,
wherein the ground layout information includes position information indicating positions of the ground facilities, and
wherein the generation module is configured to:
extract one of the plurality of water collection points arranged to overlap with a prohibition region including a facility region in which one of the ground facilities is arranged; and
move the extracted one of the plurality of water collection points to a position that does not overlap with the prohibition region.

6. The layout design support device according to claim 1,
wherein the ground layout information includes drain position information indicating positions of drains into which oil is dropped from each of the ground facilities, and oil collection tank information indicating a position of an oil collection tank that houses the oil dropped from each of the ground facilities, and
wherein the generation module is configured to generate a second piping route along which piping that connects a plurality of oil collection points arranged at the positions of the drains to the oil collection tank is buried.

7. The layout design support device according to claim 6,
wherein the generation module is configured to extract an interference region in which piping forming the first piping route interferes with piping forming the second piping route, and
wherein the output module is configured to output interference region information indicating the interference region.

8. The layout design support device according to claim 7,
wherein the information acquisition module is configured to acquire cable route information indicating a cable route along which at least one of a power cable for supplying electric power to one of the ground facilities or an instrumentation cable connected to an instrumentation facility used for control of one of the ground facilities is buried, and
wherein the generation module is configured to extract, as the interference region, a region in which the piping included in the first piping route and the second piping route interferes with the cable route.

9. The layout design support device according to claim 6,
wherein the generation module is configured to:
generate a plurality of the first piping routes and a plurality of the second piping routes; and
generate a plurality of superimposed piping routes each obtained by superimposing one of the plurality of the first piping routes and one of the plurality of the second piping routes, and
wherein the output module is configured to output a plurality of pieces of superimposed piping route information each indicating a corresponding one of the plurality of superimposed piping routes.

10. The layout design support device according to claim 9,
wherein the generation module is configured to calculate an evaluation index for evaluating constructability of construction of burying the underground facilities including the piping, and
wherein the output module is configured to output evaluation index information indicating the evaluation index, together with the plurality of pieces of superimposed piping route information.

11. A layout design support method of supporting design of a layout of underground facilities buried in underground of a plant, the layout design support method comprising:
acquiring ground layout information relating to a layout of ground facilities arranged on ground of the plant, and design condition information relating to design of the underground facilities;
generating, based on the ground layout information and the design condition information, positions of a plurality of water collection points into which a liquid is collected from the ground of the plant, and a first piping route along which piping that discharges, from the plant, the liquid collected into the plurality of water collection points is buried in the underground of the plant; and
outputting underground layout information indicating the positions of the plurality of water collection points and the first piping route.

12. A non-transitory computer readable storage medium storing a layout design support program for supporting design of a layout of underground facilities buried in underground of a plant, the layout design support program causing a computer to execute processing of:
acquiring ground layout information relating to a layout of ground facilities arranged on ground of the plant, and design condition information relating to design of the underground facilities;
generating, based on the ground layout information and the design condition information, positions of a plurality of water collection points into which a liquid is collected from the ground of the plant, and a first piping route along which piping that discharges, from the plant, the liquid collected into the plurality of water collection points is buried in the underground of the plant; and
outputting underground layout information indicating the positions of the plurality of water collection points and the first piping route.
